(19) United States
(12) Patent Application Publication
(10) Pub. No.: US 2012/0091930 A1
(43) Pub. Date: Apr. 19, 2012

(54) POWER SUPPLY SYSTEM, ELECTRIC VEHICLE PROVIDED WITH SAME, AND CONTROL METHOD OF POWER SUPPLY SYSTEM

(76) Inventors: Kenji Takahashi, Aichi-ken (JP); Yuji Nishi, Aichi-ken (JP); Shuji Tomura, Aichi-ken (JP); Takeshi Takemoto, Aichi-ken (JP); Nobuyasu Haga, Aichi-ken (JP); Tetsuya Fuchimoto, Aichi-ken (JP); Tetsuya Sugimoto, Aichi-ken (JP)

(21) Appl. No.: 13/378,688

(22) PCT Filed: Jun. 29, 2010
(86) PCT No.: PCT/IB2010/001579

§ 371 Date: Dec. 16, 2011

(30) Foreign Application Priority Data
Jun. 30, 2009 (JP) 2009-154910

(51) Int. Cl. H02P 1/00; H02J 1/00

(52) U.S. Cl. 318/139; 307/80

(57) ABSTRACT

When it is determined by a determining portion (54) that the SOC of a first auxiliary power storage device (BB1) has reached a first lower limit value (TL), a switching control portion (56) generates a switching signal (SW) to switch from the first auxiliary power storage device (BB1) to the second auxiliary power storage device (BB2). A SOC estimating portion (52) measures the OCV for the first auxiliary power storage device (BB1), for which it has been determined that the SOC has reached the first lower limit value (TL) and has thus been disconnected, and estimates the SOC of that first auxiliary power storage device (BB1), based on that measured OCV. If the estimated SOC is higher than the first lower limit value (TL), after the SOC of the second auxiliary power storage device (BB2) has reached the first lower limit value (TL), the switching control portion (56) generates a switching signal (SW) to switch from the second auxiliary power storage device (BB2) to the first auxiliary storage device (BB1).

### BACKGROUND OF THE INVENTION

1. Field of the Invention

The invention relates to a power supply system, an electric vehicle provided with that power supply system, and a control method of a power supply system. More particularly, the invention relates to a power supply system that includes a plurality of power storage devices that are selectively used sequentially, an electric vehicle provided with that power supply system, and a control method of a power supply system.

2. Description of the Related Art

Japanese Patent Application Publication No. 2008-109840 (JP-A-2008-109840) describes a power supply system provided with a plurality of power storage devices that are selectively used sequentially. In this power supply system, two power storage portions B1 and B2 are connected to a single converter via a relay. When the state-of-charge (SOC) of the power storage portion B1 in use reaches a lower limit value SL, the power storage portion switches from the power storage portion B1 to the power storage portion B2 and the power storage portion B2 is then used.

When a plurality of power storage devices are selectively used sequentially, as with the power supply system described above, and there is error in the estimated value of the SOC, the power storage device will switch even though the actual SOC has not reached to the lower limit value. As a result, the electric energy that is available to be used may not be able to be sufficiently used.

### SUMMARY OF THE INVENTION

The invention thus provides a power supply system capable of sufficiently using electric energy stored in a plurality of power storage devices that are selectively used sequentially, as well as to an electric vehicle provided with this power supply system.

Further, the invention also provides a control method of a power system capable of sufficiently using electric energy stored in a plurality of power storage devices that are selectively used sequentially.

A first aspect of the invention relates to a power supply system. This power supply system includes a plurality of power storage devices; a connecting device that is provided between the plurality of power storage devices and an electrical system that receives a supply of electric power from the plurality of power storage devices, and is structured to selectively electrically connect and disconnect the plurality of power storage devices to and from the electrical system; and a control apparatus that sequentially selects one of the plurality of power storage devices, connects the selected power storage device to the electrical system, and controls the connecting device to disconnect the remaining power storage device from the electrical system. The control apparatus includes a) a state-of-charge estimating portion that estimates the state-of-charge of each of the plurality of power storage devices, b) a determining portion that determines whether the state-of-charge of the power storage device that is connected to the electrical system by the connecting device has reached a first lower limit value, and c) a switch controlling portion that, when it is determined by the determining portion that the state-of-charge of the power storage device that is connected to the electrical system has reached the first lower limit value, controls the connecting device to disconnect the power storage device that is connected to the electrical system from the electrical system and connect one of the remaining power storage devices having a state-of-charge that has not reached the first lower limit value to the electrical system.

Here, the state-of-charge estimating portion estimates the state-of-charge of the used power storage device, for which it has been determined that the state-of-charge has reached the first lower limit value and has thus been disconnected from the electrical system, based on an open circuit voltage of that power storage device. If the state-of-charge estimated based on the open circuit voltage of the used power storage device is higher than the first lower limit value, after the remaining power storage device has been used, the switching control portion controls the connecting device to connect the used power storage device to the electrical system again and disconnect the remaining power storage device from the electrical system.

In the aspect described above, the state-of-charge estimating portion may estimate the state-of-charge of the used power storage device based on the open circuit voltage of that power storage device when the state-of-charge of the remaining power storage device reaches the first lower limit value.

In the structure described above, the control apparatus may operate the switching control portion when a voltage change of the open circuit voltage, that is due to a diffusion phenomenon of reactants in an electrolyte solution or active battery material that occurs, after current has run through the power storage device that is connected to the electrical system, has converged.

In the structure described above, the electrical supply system may include an electrical load apparatus, a main power storage device that is different than the plurality of power storage devices, a first voltage converter provided between the main power storage device and a power line for supplying power to the electrical load apparatus, a second voltage converter provided between the power line and the connecting device, and a charging device for charging the main power storage device and the plurality of power storage devices from an external power supply.

In the structure described above, when a temporarily unused condition of the power storage device that is connected to the electrical system is satisfied, the switching control portion may transfer electric power from the remaining power storage device to the power storage device that is connected to the electrical system, even if the state-of-charge of the power storage device that is connected to the electrical system has not reached the first lower limit value.

In the structure described above, the plurality of power storage devices may include a first auxiliary power storage device and a second auxiliary power storage device. Also, when it is determined that the state-of-charge of the first auxiliary power storage device that is connected to the electrical system has reached a second lower limit value that is greater than the first lower limit value before switching control that is based on the first lower limit value is performed, the switching control portion may disconnect the first auxiliary power storage device that is connected to the electrical system from the electrical system and connect the second auxiliary power storage device to the electrical system. Further, when it is determined that the state-of-charge of the second auxiliary power storage device that is connected to the electrical system has reached the second lower limit value that is greater than the first lower limit value before the switching control that is based on the first lower limit value is performed, the switching control portion may disconnect the second auxiliary power storage device that is connected to the electrical system from the electrical system and connect the first auxiliary power storage device to the electrical system.

A second aspect of the invention relates to an electric vehicle. This electric vehicle includes the power supply system according to the first aspect and a driving force generating portion that receives a supply of electric power from the power supply system and generates driving force for the vehicle.

A third aspect of the invention relates to a control method of a power supply system that includes a plurality of power storage devices, and a connecting device that is provided between the plurality of power storage devices and an electrical system that receives a supply of electric power from the plurality of power storage devices, and is structured to selectively electrically connect and disconnect the plurality of power storage devices to and from the electrical system. This control method includes determining whether a state-of-charge of the power storage device that is connected to the electrical system has reached a first lower limit value; controlling the connecting device to disconnect the power storage device that is connected to the electrical system from the electrical system and connect one of the remaining power storage devices having a state-of-charge that has not reached the first lower limit value to the electrical system, when it is determined that the state-of-charge of the power storage device that is connected to the electrical system has reached the first lower limit value; estimating the state-of-charge of the used power storage device, for which it has been determined that the state-of-charge has reached the first lower limit value and has thus been disconnected from the electrical system, based on an open circuit voltage of that power storage device; and controlling the connecting device to connect the used power storage device to the electrical system again and disconnect the remaining power storage device from the electrical system after the remaining power storage device has been used, when the state-of-charge estimated based on the open circuit voltage of the used power storage device is higher than the first lower limit value.

In the aspect described above, the state-of-charge of the used power storage device may be estimated based on the open circuit voltage of that power storage device when the state-of-charge of the remaining power storage device reaches the first lower limit value.

In the structure described above, the power storage device may be switched when a voltage change of the open circuit voltage, that is due to a diffusion phenomenon of reactants in an electrolyte solution or active battery material or the like that occurs after current has run through the power storage device that is connected to the electrical system, has converged.

In the structure described above, the electrical system may include an electrical load apparatus, a main power storage device that is different than the plurality of power storage devices, a first voltage converter provided between the main power storage device and a power line for supplying power to the electrical load apparatus, a second voltage converter provided between the power line and the connecting device, and a charging device for charging the main power storage device and the plurality of power storage devices from an external power supply.

In the structure described above, when a temporarily unused condition of the power storage device that is connected to the electrical system is satisfied, electric power may be transferred from the remaining power storage device to the power storage device that is connected to the electrical system, even if the state-of-charge of the power storage device that is connected to the electrical system has not reached the first lower limit value.

In the structure described above, the plurality of power storage devices may include a first auxiliary power storage device and a second auxiliary power storage device. Also, when it is determined that the state-of-charge of the first auxiliary power storage device that is connected to the electrical system has reached a second lower limit value that is greater than the first lower limit value before switching control that is based on the first lower limit value is performed, the first auxiliary power storage device that is connected to the electrical system may be disconnected from the electrical system and the second auxiliary power storage device may be connected to the electrical system. Further, when it is determined that the state-of-charge of the second auxiliary power storage device that is connected to the electrical system has reached the second lower limit value that is greater than the first lower limit value before the switching control that is based on the first lower limit value is performed, the second auxiliary power storage device that is connected to the electrical system may be disconnected from the electrical system and the first auxiliary power storage device may be connected to the electrical system.

According to the aspects described above, the state-of-charge of the used power storage device for which it has been determined that the state-of-charge has reached the first lower limit value and has thus been disconnected from the electrical system, is estimated based on the open circuit voltage of that power storage device. As a result, the state-of-charge of the used power storage device can be accurately estimated. If that estimated state-of-charge of the is higher than the first lower limit value, then after the remaining power storage device has been used, the used power storage device is again connected to the electrical system. Therefore, according to the invention it is possible to sufficiently use the electric energy stored in a plurality of power storage devices.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a block diagram of the entire electric vehicle provided with a power supply system according to the example embodiments of the invention;

FIG. 2 is a block diagram schematically showing the first and second converters in FIG. 1;

FIG. 3 is a view illustrating the basic concept of the method of use of the power storage devices;

FIG. 4 is a view illustrating a characteristic portion of the method of use of the power storage devices according to the first example embodiment;

FIG. 5 is a functional block diagram of a portion related to switching control of the first auxiliary power storage device and the second auxiliary power storage device in the ECU shown in FIG. 1;

FIG. 6 is a first flowchart illustrating the first part of a routine of the switching control of the first auxiliary power storage device and the second auxiliary power storage device by the ECU shown in FIG. 1;

FIG. 7 is a second flowchart illustrating the second part of the routine of the switching control of the first auxiliary power storage device and the second auxiliary power storage device by the ECU shown in FIG. 1;

FIG. 8 is a flowchart illustrating an energy transfer routine executed by the ECU according to a second example embodiment of the invention;

FIG. 9 is a flowchart illustrating a routine for transferring energy from the second auxiliary power storage device to the main power storage device;

FIG. 10 is a flowchart illustrating routine for transferring energy from the main power storage device to the second auxiliary power storage device;

FIG. 11 is a graph showing the relationship between the SOC of the power storage devices and the allowable power output that represents the maximum value of power able to be output instantaneously from the power storage devices; and

FIG. 12 is a flowchart illustrating a switching control routine of the first auxiliary power storage device and the second auxiliary power storage device that is executed by the ECU according to a third example embodiment of the invention.

### DETAILED DESCRIPTION OF EMBODIMENTS

Hereinafter, a first example embodiment of the invention will be described in detail below with reference to the accompanying drawings. Incidentally, like or corresponding parts will be denoted by like reference characters and descriptions of those parts will not be repeated.

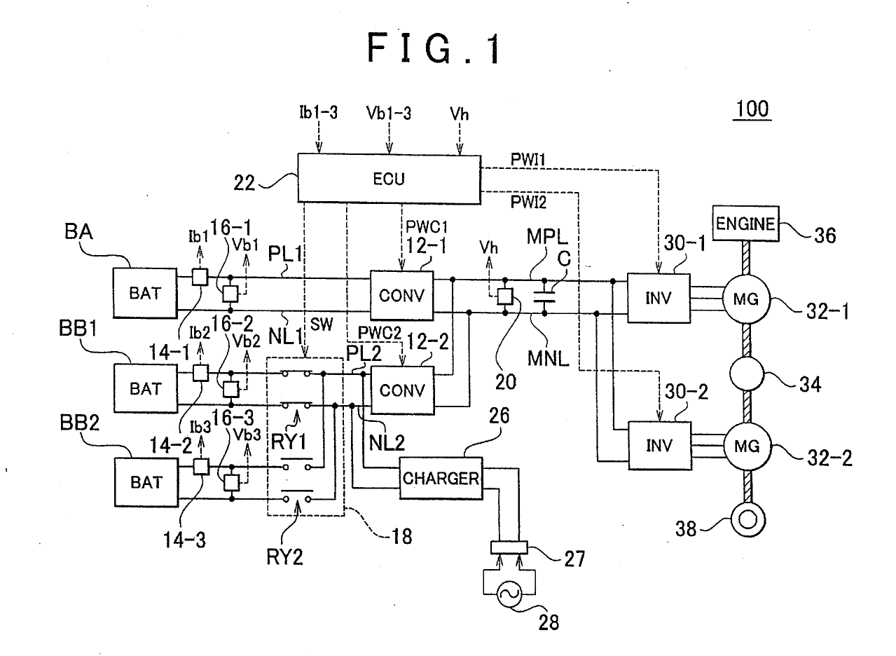

FIG. 1 is a block diagram of the entire electric vehicle provided with a power supply system according to the first example embodiment of the invention. Referring to FIG. 1, an electric vehicle 100 includes a main power storage device BA, a first auxiliary power storage device BB1, a second auxiliary power storage device BB2, a connecting device 18, a first converter 12-1, a second converter 12-2, and a smoothing capacitor C. The electric vehicle 100 also includes current sensors 14-1 to 14-3, voltage sensors 16-1 to 16-3 and 20, an ECU 22, a charger 26, and a charging inlet 27. Moreover, the electric vehicle 100 includes a first inverter 30-1, a second inverter 30-2, a first MG (Motor-Generator) 32-1, a second MG 32-2, a power split device 34, an engine 36, and driving wheels 38.

Each of the main power storage device BA, the first auxiliary power storage device BB1, and the second auxiliary power storage device BB2 is a direct current power supply capable of being recharged and is formed from an electric double layer capacitor, or a secondary battery such as a nickel-metal hydride battery or a lithium-ion battery or the like, for example. The main power storage device BA is connected to the first converter 12-1 via a positive electrode line PL1 and a negative electrode line NL1. The first auxiliary power storage device BB1 and the second auxiliary power storage device BB2 are connected to the connecting device 18.

The connecting device 18 is provided between the second converter 12-2 and both the first auxiliary power storage device BB1 and the second auxiliary power storage device BB2, and electrically connects either the first auxiliary power storage device BB1 or the second auxiliary power storage device BB2 to the second converter 12-2 according to a switching signal SW from the ECU 22. More specifically, the connecting device 18 includes system relays RY1 and RY2. The system relay RY1 is arranged between the first auxiliary power storage device BB1 and the second converter 12-2. The system relay RY2 is arranged between the second auxiliary power storage device BB2 and the second converter 12-2. For example, when the switching signal SW is activated, the system relay RY1 turns on and the system relay RY2 turns off such that the first auxiliary power storage device BB1 is electrically connected to the second converter 12-2. When the switching signal SW is de-activated, the system relay RY1 turns off and the system relay RY2 turns on such that the second auxiliary power storage device BB2 is electrically connected to the second converter 12-2.

The first converter 12-1 and the second converter 12-2 are connected in parallel to a main positive bus MPL and a main negative bus MNL. The first converter 12-1 performs voltage conversion between the main power storage device BA and both the main positive bus MPL and the main negative bus MNL based on a drive signal PWC1 from the ECU 22. The second converter 12-2 performs voltage conversion between either the first auxiliary power storage device BB1 or the second auxiliary power storage device BB2 that is electrically connected to the second converter 12-2 by the connecting device 18, and both the main positive bus MPL and the main negative bus MNL, based on a drive signal PWC2 from the ECU 22.

The smoothing capacitor C is connected between the main positive bus MPL and the main negative bus MNL, and reduces the alternating current component in the direct current voltage between the main positive bus MPL and the main negative bus MNL. The charger 26 is a device that charges the power storage devices from a power source 28 outside the vehicle. This charger 26 is connected to a positive electrode line PL2 and a negative electrode line NL2 that are arranged between the second converter 12-2 and the connecting device 18, for example. The charger 26 converts the power input from the charging inlet 27 into direct current and outputs this direct current to the positive electrode line PL2 and the negative electrode line NL2.

Incidentally, when the main power storage device BA is charged by the charger 26, the first converter 12-1 and the second converter 12-2 are driven appropriately, and charging power is supplied to the main power storage device BA via the main positive bus MPL and the main negative bus MNL, and the first converter 12-1 in that order. Also, when the first auxiliary power storage device BB1 is charged by the charger 26, the system relay RY1 is turned on such that charging power is supplied from the charger 26 to the first auxiliary power storage device BB1. When the second auxiliary power storage device BB2 is charged by the charger 26, the system relay RY2 is turned on such that charging power is supplied from the charger 26 to the second auxiliary power storage device BB2.

The first inverter 30-1 and the second inverter 30-2 are connected to the main positive bus MPL and the main negative bus MNL. The first inverter 30-1 converts the driving power (direct current power) supplied from the main positive bus MPL and the main negative bus MNL into alternating current power which it outputs to the first MG 32-1. Similarly, the second inverter 30-2 converts the driving power (direct current power) supplied from the main positive bus MPL and the main negative bus MNL into alternating current power which it outputs to the second MG 32-2. Moreover, the first inverter 30-1 converts alternating current power generated by the first MG 32-1 into direct current power and outputs it as regenerated power to the main positive bus MPL and the main negative bus MNL, while the second inverter 30-2 converts alternating current power generated by the second MG 32-2 into direct current power and outputs it as regenerated power to the main positive bus MPL and the main negative bus MNL.

Incidentally, the first inverter 30-1 and the second inverter 30-2 are each formed from a bridge circuit that includes switching elements for three phases. The inverters drive the corresponding motor-generators by performing a switching operation according to a drive signal from the ECU 22.

The first MG 32-1, the second MG 32-2, and the engine 36 are all connected to the power split device 34. This electric vehicle 100 runs using driving force from at least one of the engine 36 or the second MG 32-2. The power generated by the engine 36 is split into two paths by the power split device 34. One path is a path along which power is transmitted to the driving wheels 38, and the other path is a path along which power is transmitted to the first MG 32-1.

The first MG 32-1 and the second MG 32-2 are each an alternating current rotating electrical machine that is formed, for example, from a three-phase alternating current rotating electrical machine that includes a rotor with a permanent magnet embedded in it. The first MG 32-1 generates power using the power from the engine 36 that has been split by the power split device 34. For example, if the SOC of the main power storage device BA decreases in an HV (Hybrid Vehicle) mode in which the vehicle runs while keeping the electric power stored in the main power storage device BA at a predetermined target, the engine 36 is started and power is generated by the first MG 32-1, and the main power storage device BA is charged.

The second MG 32-2 generates driving force using electric power supplied from the main positive bus MPL and the main negative bus MNL. The driving force from the second MG 32-2 is transmitted to the driving wheels 38. Incidentally, during braking of the vehicle, the second MG 32-2 is driven using the kinetic energy of the vehicle received from the driving wheels 38, and the second MG 32-2 operates as a generator. That is, the second MG 32-2 operates as a regenerative brake capable of achieving braking force, by converting the kinetic energy of the vehicle into electric power. The electric power generated by the second MG 32-2 is then supplied to the main positive bus MPL and the main negative bus MNL.

The power split device 34 is formed from a planetary gear set that includes a sun gear, pinion gears, a carrier, and a ring gear. The pinion gears are in mesh with the sun gear and the ring gear. The carrier rotatably supports the pinion gears and is coupled to a crankshaft of the engine 36. The sun gear is coupled to a rotating shaft of the first MG 32-1. The ring gear is coupled to a rotating shaft of the second MG 32-2.

The current sensors 14-1, 14-2, and 14-3 detect a current Ib1 input and output with respect to the main power storage device BA, a current Ib2 input and output with respect to the first auxiliary power storage device BB1, and a current Ib3 input and output with respect to the second auxiliary power storage device BB2, respectively, and output the detection values to the ECU 22. Incidentally, each current sensor 14-1 to 14-3 detects the current output from the corresponding power storage device (i.e., discharged current) as a positive value and detects the current input to the corresponding power storage device (i.e., charged current) as a negative value. Incidentally, FIG. 1 shows a case in which the current sensors 14-1 to 14-3 detect the current of the positive electrode line, but the current sensors 14-1 to 14-3 may also detect the current of the negative electrode line.

The voltage sensors 16-1, 16-2, and 16-3 detect a voltage Vb1 of the main power storage device BA, a voltage Vb2 of the first auxiliary power storage device BB1, and a voltage Vb3 of the second auxiliary power storage device BB2, respectively, and output the detection values to the ECU 22. The voltage sensor 20 detects a voltage Vh between the main positive bus MPL and the main negative bus MNL, and outputs the detection value to the ECU 22.

The ECU 22 generates a switching signal SW for selectively using the first auxiliary power storage device BB1 and the second auxiliary power storage device BB2 sequentially and outputs that switching signal SW to the connecting device 18. For example, after the first auxiliary power storage device BB1 and the second auxiliary power storage device BB2 have finished being charged by the charger 26, the ECU 22 first turns the system relay RY1 on and the system relay RY2 off to use the first auxiliary power storage device BB1. Then when the SOC of the first auxiliary power storage device BB1 reaches the lower limit value, the ECU 22 generates a switching signal SW to turn the system relay RY1 off and the system relay RY2 on to use the second auxiliary power storage device BB2.

Also, the ECU 22 generates the drive signal PWC1 to drive the first converter 12-1 and the drive signal PWC2 to drive the second converter 12-2, based on the detection values from the current sensors 14-1 to 14-3 and the voltage sensors 16-1 to 16-3 and 20. Then the ECU 22 outputs the generated drive signal PWC1 to the first converter 12-1 and outputs the generated drive signal PWC2 to the second converter 12-2 and controls the first converter 12-1 and the second converter 12-2.

Incidentally, the ECU 22 controls the first converter 12-1 to adjust the voltage Vh to a predetermined target, and controls the second converter 12-2 to adjust the charge-discharge electricity of the power device that is electrically connected to the second converter 12-2 by the connecting device 18 to a predetermined target. Incidentally, in this example embodiment, the first converter 12-1 functions as a master converter, and the second converter 12-2 functions as a slave converter.

Also, the ECU 22 calculates a target torque value and a target rotation speed value for both the first MG 32-1 and the second MG 32-2 based on the running state of the vehicle and the operation amount of the accelerator pedal and the like, and controls the first inverter 30-1 and the second inverter 30-2 such that the generated torque and the rotation speeds of the first MG 32-1 and the second MG 32-2 come to match the target values.

Moreover, the ECU controls the running mode. More specifically, when the power storage devices have finished being charged by the charger 26, the ECU 22 sets an EV (Electric Vehicle) mode in which the vehicle runs using the electric power stored in the power storage devices instead of maintaining it, as the default running mode. When the SOC of both the first auxiliary power storage device BB1 and the second auxiliary power storage device BB2 reaches the lower limit value, the ECU 22 switches the running mode from the EV mode to the HV mode.

Incidentally, in the EV mode, as long as a large amount of power is not required for the vehicle, the engine 36 is shut off and the vehicle is run using only the second MG 32-2, so the electric power stored in the power storage devices decreases. On the other hand, in the HIT mode, the engine 36 is operated appropriately and power is generated by the first MG 32-1, so the SOC of the main power storage device BA is maintained at a predetermined target.

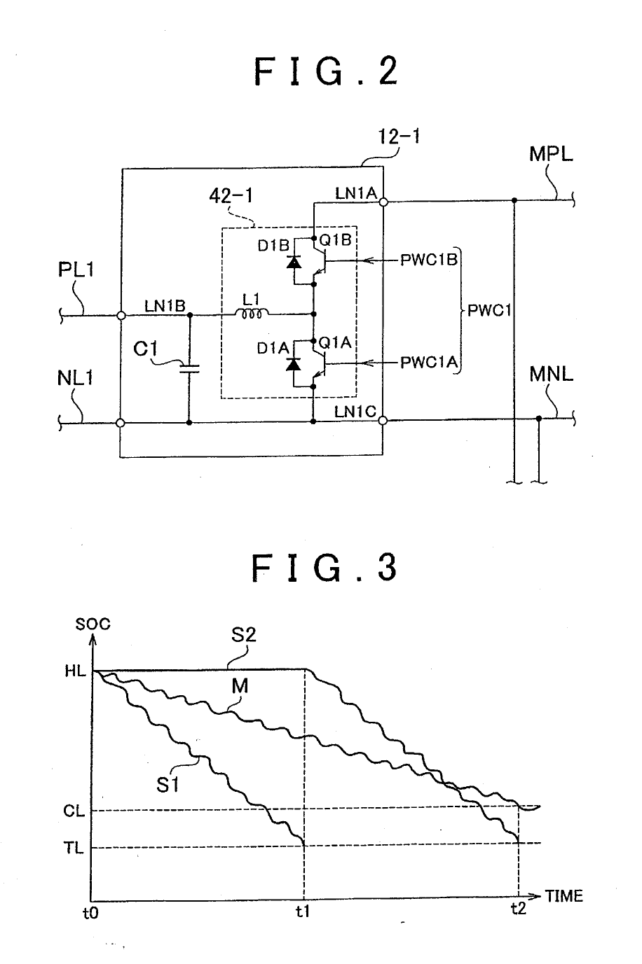

FIG. 2 is a block diagram schematically showing the first and second converters 12-1 and 12-2 shown in FIG. 1. Incidentally, the structure and operation of both of these converters is the same so only the structure and operation of the first converter 12-1 will be described. Referring to FIG. 2, the first converter 12-1 includes a chopper circuit 42-1, a positive bus LN1A, a negative bus LN1C, a line LN1B, and a smoothing capacitor C1. The chopper circuit 42-1 includes switching elements Q1A and Q1B, diodes D1A and D1B, and an inductor L1.

The positive bus LN1A is connected to a collector of the switching element Q1B at one end, and to the main positive bus MPL at the other end. The negative bus LN1C is connected to the negative electrode line NL1 at one end, and to the main negative bus MNL at the other end.

The switching elements Q1A and Q1B are connected in series between the negative bus LN1C and the positive bus LN1A. More specifically, an emitter of the switching element Q1A is connected to the negative bus LN1C and the collector of the switching element Q1B is connected to the positive bus LN1A. The diodes D1A and D1B are connected back-to-back (i.e., inversely parallel) to the switching elements Q1A and Q1B, respectively, and the inductor L1 is connected between the line. LN1B and connecting nodes of the switching elements Q1A and Q1B.

The line LN1B is connected to the positive electrode line PL1 at one end, and to the inductor L1 at the other end. The smoothing capacitor C1 is connected between the line LN1B and the negative bus LN1C, and reduces the alternating current component in the direct current voltage between the line LN1B and the negative bus LN1C.

The chopper circuit 42-1 performs direct current voltage conversion between the main power storage device BA (FIG. 1) and both the main positive bus MPL and the main negative bus MNL, according to the drive signal PWC1 from the ECU 22 (FIG. 1). The drive signal PWC1 includes a drive signal PWC1A that controls the switching element Q1A that forms a lower arm element on and off, and a drive signal PWC1B that controls the switching element Q1B that forms an upper arm element on and off. The duty ratio (i.e., the on/off period ratio) of the switching elements Q1A and Q1B in a given duty cycle (i.e., the sum of one on period and one off period) is controlled by the ECU 22.

When the switching elements Q1A and Q1B are controlled such that the on duty of the switching element Q1A becomes large (the switching elements Q1A and Q1B are controlled on and off complementarily except for during the dead time period, so the on duty of the switching element Q1B becomes smaller), the pump current amount that flows from the main power storage device BA to the inductor L1 increases, so the electromagnetic energy stored in the inductor L1 increases. As a result, when the switching element Q1A switches from on to off, the amount of current discharged from the inductor L1 to the main positive bus MPL via the diode D1B increases, so the voltage of the main positive bus MPL increases.

On the other hand, when the switching elements Q1A and Q1B are controlled such that the on duty of the switching element Q1B becomes larger (the on duty of the switching element Q1A becomes smaller) the amount of current that flows from the main positive bus MPL to the main power storage device BA via the switching element Q1B and the inductor L1 increases, so the voltage of the main positive bus MPL decreases.

Controlling the duty ratio of the switching elements Q1A and Q1B in this way makes it possible to control the voltage between the main positive bus MPL and the main negative bus MNL, and control the amount of current (i.e., the amount of power) that flows between the main power storage device BA and the main positive bus MPL, as well as the direction of that current (i.e., power).

FIG. 3 is a view illustrating the basic concept of the method of use of the power storage devices. Incidentally, here the SOC lower limit value of the first auxiliary power storage device BB1 and the SOC lower limit value of the second auxiliary power storage device BB2 are the same. Also, in FIG. 3, the vehicle starts to run from a state in which the power storage devices have been charged to the highest limit value UL of the fully charged state by the charger 26.

Referring to FIG. 3, the line M represents the temporal change (i.e., the change over time) in the SOC of the main power storage device BA. Also, the line S1 represents the temporal change (i.e., the change over time) in the SOC of the first auxiliary power storage device BB1, and the line S2 represents the temporal change (i.e., the change over time) in the SOC of the second auxiliary power storage device BB2.

Of the first auxiliary power storage device BB1 and the second auxiliary power storage device BB2 that are selectively used by the connecting device 18, the first auxiliary power storage device BB1 is used first. The vehicle starts running in the EV mode from time t0, and the SOC of the main power storage device BA and the first auxiliary power storage device BB1 decrease as the electric power in the main power storage device BA and the first auxiliary power storage device BB1 is consumed. When the SOC of the first auxiliary power storage device BB1 reaches the lower limit value TL at time t1, the power storage device connected to the second converter 12-2 is switched from the first auxiliary power storage device BB1 to the second auxiliary power storage device BB2 by the connecting device 18. Then after time t1, the vehicle is run using electric power from the main power storage device BA and the second auxiliary power storage device BB2, and at time t2 the SOC of the second auxiliary power storage device BB2 reaches the lower limit value TL. After time t2, the running mode switches to the HV mode so the SOC of the main power storage device BA is maintained at the target value CL.

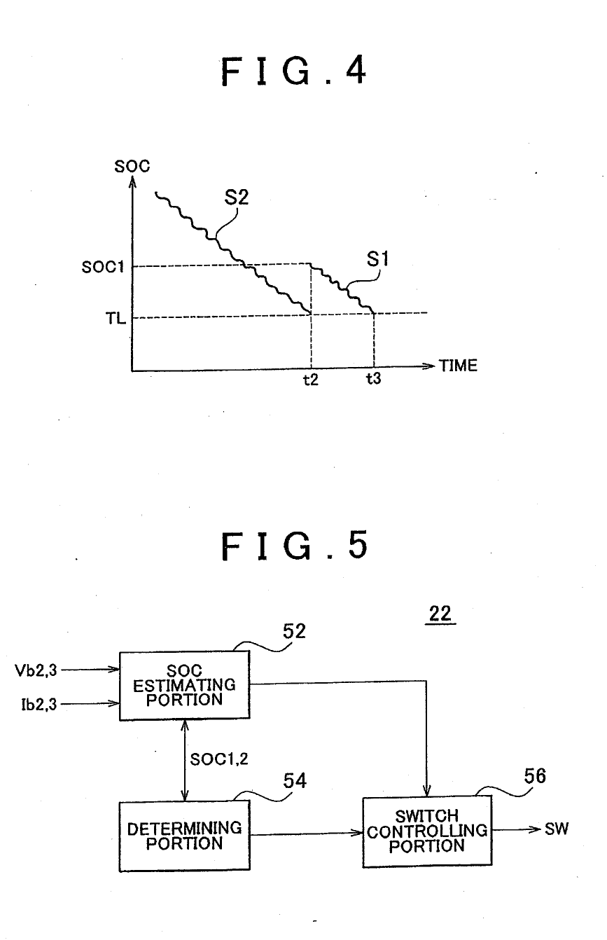

FIG. 4 is a view illustrating a characteristic portion of the method of use of the power storage devices according to the first example embodiment. Referring to FIG. 4, in the first example embodiment, when it is determined that the SOC of the first auxiliary power storage device BB1 has reached the lower limit value TL and, as a result, the first auxiliary power storage device BB1 is disconnected from the second converter 12-2 and the second auxiliary power storage device BB2 is used, the OCV of the first auxiliary power storage device BB1 that is electrically disconnected is calculated and the SOC of the first auxiliary power storage device BB1 is estimated based on that calculated SOC. For example, at time t2 when the SOC of the second auxiliary power storage device BB2 has reached the lower limit value TL, the OCV of the first auxiliary power storage device BB1 is calculated and the SOC of the first auxiliary power storage device BB1 is estimated based on that calculation result.

After the SOC of the second auxiliary power storage device BB2 reaches the lower limit value TL when the difference of the estimated SOC of the first auxiliary power storage device BB1 (hereinafter simply referred to as “SOC1”) minus the lower limit value TL is greater than a predetermined value, the connecting device 18 switches the power storage device that is connected to the second converter 12-2 from the second auxiliary power storage device BB2 back to the first auxiliary power storage device BB1 again, such that the first auxiliary power storage device BB1 is used again.

That is, while the first auxiliary power storage device BB1 is being used, the SOC is unable to be accurately estimated because, for example, with the SOC estimation using current integration, estimation error accumulates and with SOC estimation using the OCV, the OCV is unable to be accurately measured due to the effect of polarization and the like. Therefore, even if it is determined that the SOC of the first auxiliary power storage device BB1 has reached the lower limit value TL at time t1 (FIG. 3), it is possible that, due to the estimation error, the first auxiliary power storage device BB1 is actually still able to be used. Therefore, in this first example embodiment, after the power storage device has been switched from the first auxiliary power storage device BB1 to the second auxiliary power storage device BB2, the OCV of the first auxiliary power storage device BB1 that is not being used is measured while the second auxiliary power storage device BB2 is being used, and the SOC of the first auxiliary power storage device BB1 is estimated based on that measured OCV. If that estimated SOC is greater than the lower limit value TL, the first auxiliary power storage device BB1 is used again after the second auxiliary power storage device BB2 has reached the lower limit value TL. As a result, the electric power stored in the first auxiliary power storage device BB1 is able to be sufficiently used up.

Incidentally, the first auxiliary power storage device BB1 must reach a relaxed state to be able to more accurately measure the OCV of the first auxiliary power storage device BB1. Here, a relaxed state is a state in which a voltage change due to a diffusion phenomenon of reactants in the electrolyte solution or active battery material or the like, that occurs after current has run through the power storage device, has converged such that the voltage has become constant. It takes some time for the power storage device to reach this relaxed state after being used. Therefore, as an example, in this first example embodiment, the OCV of the first auxiliary power storage device BB1 is measured when the first auxiliary power storage device BB1 has reached a relaxed state at the timing (timing t2) when the SOC of the second auxiliary power storage device BB2 reaches the lower limit value TL after the power storage device has been switched from the first auxiliary power storage device BB1 to the second auxiliary power storage device BB2.

Incidentally, the OCV of the second auxiliary power storage device BB2 while the first auxiliary power storage device BB1 is being used again is measured (at the timing when the SOC of the first auxiliary power storage device BB1 has reached the lower limit value TL) and the SOC of the second auxiliary power storage device BB2 is estimated basted on that measured OCV. If that estimated SOC is higher than the lower limit value TL, the second auxiliary power storage device BB2 may be used again after the first auxiliary power storage device BB1 has reached the lower limit value TL.

FIG. 5 is a functional block diagram of a portion related to switching control of the first auxiliary power storage device BB1 and the second auxiliary power storage device BB2 in the ECU 22 shown in FIG. 1. Referring to FIG. 5, the ECU 22 includes a SOC estimating portion 52, a determining portion 54, and a switch controlling portion 56.

The SOC estimating portion 52 calculates the SOC of the first auxiliary power storage device BB1 (i.e., the SOC 1) by integrating the current Ib2 detected by the current sensor 14-2 (FIG. 1) while the first auxiliary power storage device BB1 is being used, and outputs the calculation result to the determining portion 54. Also, the SOC estimating portion 52 calculates the SOC of the second auxiliary power storage device BB2 (i.e., the SOC2) by integrating the current Ib3 detected by the current sensor 14-3 (FIG. 1) while the second auxiliary power storage device BB2 is being used, and outputs the calculation result to the determining portion 54.

Also, upon receiving a signal from the determining portion 54 indicating that the SOC of the second auxiliary power storage device BB2 has reached the lower limit value TL, the SOC estimating portion 52 measures the OCV of the first auxiliary power storage device BB1 that is not being used based on the voltage Vb2 detected by the voltage sensor 16-2 (FIG. 1), and estimates the SOC of the first auxiliary power storage device BB1 based on that estimated OCV using an OCV-SOC map or the like prepared in advance. If the difference of that estimated SOC minus the lower limit value TL is greater than a predetermined value (such as 5%), the SOC estimating portion 52 outputs a signal instructing the switch controlling portion 56 to again switch the power storage device from the second auxiliary power storage device BB2 to the first auxiliary power storage device BB1.

Moreover, upon receiving a signal indicating that the SOC of the first auxiliary power storage device BB1 has reached the lower limit value TL after the power storage device has been switched again from the second auxiliary power storage device BB2 to the first auxiliary power storage device BB1, the SOC estimating portion measures the OCV of the second auxiliary power storage device BB2 that is not being used based on the voltage Vb3 detected by the voltage sensor 16-3 (FIG. 1), and estimates the SOC of the second auxiliary power storage device BB2 based on that measured OCV using the OCV-SOC map or the like. If the difference of that estimated SOC minus the lower limit value TL is greater than a predetermined value (such as 5%), the SOC estimating portion 52 outputs a signal instructing the switch controlling portion 56 to again switch the power storage device from the first auxiliary power storage device BB1 to the second auxiliary power storage device BB2.

While the first auxiliary power storage device BB1 is being used, the determining portion 54 determines whether the SOC of the first auxiliary power storage device BB1 (i.e., SOC1) calculated by the SOC estimating portion 52 has reached the lower limit value TL. If the determining portion 54 determines that the SOC1 has reached the lower limit value TL, the determining portion 54 outputs a signal indicating such to the switch controlling portion 56 and the SOC estimating portion 52. Similarly, while the second auxiliary power storage device BB2 is being used, the determining portion 54 determines whether the SOC of the second auxiliary power storage device BB2 (i.e., SOC2) calculated by the SOC estimating portion 52 has reached the lower limit value TL. If the determining portion 54 determines that the SOC2 has reached the lower limit value TL, the determining portion 54 outputs a signal indicating such to the switch controlling portion 56 and the SOC estimating portion 52.

Upon receiving a signal from the determining portion 54 indicating that the SOC of the first auxiliary power storage device BB1 has reached the lower limit value TL, the switch controlling portion 56 outputs a switching signal SW to the connecting device 18 to turn the system relay RY1 (FIG. 1) of the connecting device 18 off and turn the system relay RY2 (FIG. 1) on.

Further, upon receiving a signal from the SOC estimating portion 52 indicating that the power storage device will be switched again from the second auxiliary power storage device BB2 to the first auxiliary power storage device BB1 while the second auxiliary power storage device BB2 is being used, the switch controlling portion 56 outputs a switching signal SW to the connecting device 18 to turn the system relay RY1 (FIG. 1) on and turn the system relay RY2 (FIG. 1) off. After that, upon receiving a signal from the SOC estimating portion 52 indicating that the power storage device will again be switched from the first auxiliary power storage device BB1 to the second auxiliary power storage device BB2, the switch controlling portion 56 outputs a switching signal SW to the connecting device 18 to turn the system relay RY1 off and turn the system relay RY2 on.

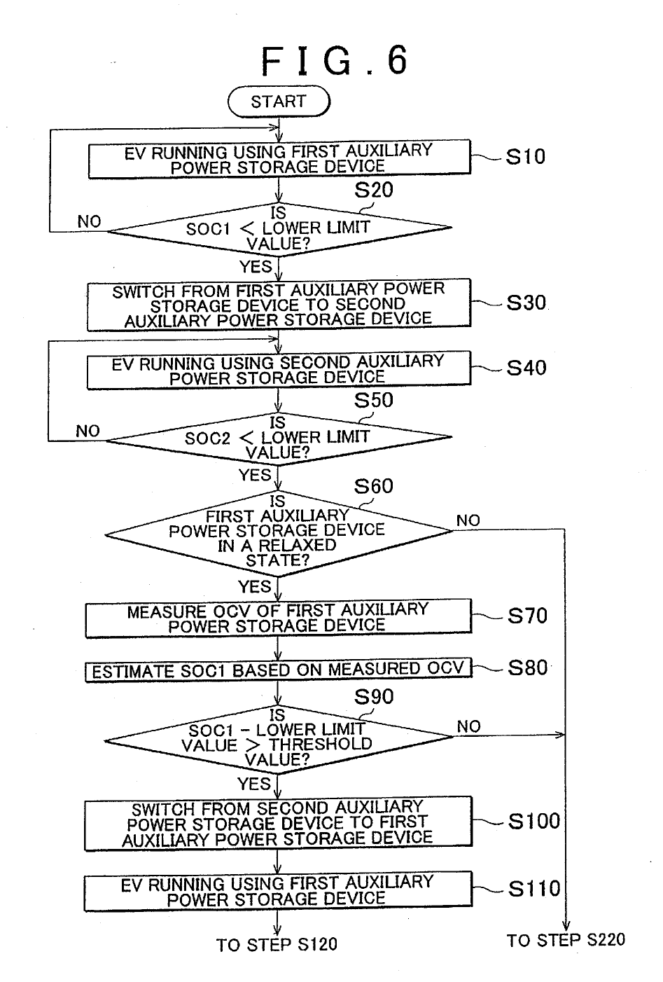

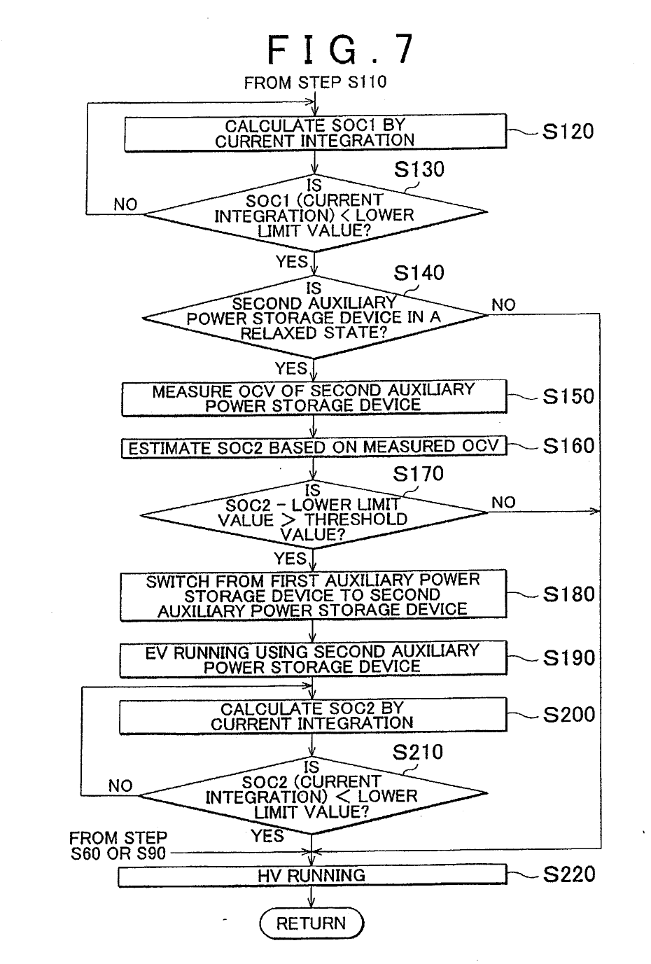

FIGS. 6 and 7 are flowcharts illustrating a routine of the switching control of the first auxiliary power storage device BB1 and the second auxiliary power storage device BB2 by the ECU 22 shown in FIG 1. Incidentally, the routine shown in the flowcharts is called up from a main routine and executed at regular intervals of time or when a predetermined condition is satisfied.

Referring to FIG. 6, the ECU 22 first outputs the switching signal SW to the connecting device 18 to turn the system relay RY1 (FIG. 1) of the connecting device 18 on and the system relay RY2 (FIG. 1) of the connecting device 18 off. Accordingly, EV running (i.e., running in the EV mode) using the first auxiliary power storage device BB1 is realised (step S10). Then the ECU 22 determines whether the SOC of the first auxiliary power storage device BB1 (i.e., the SOC1) is less than the lower limit value TL (step S20). If the SOC1 is equal to or greater than the lower limit value TL (i.e., NO in step S20), the process returns to step S10 and EV running using the first auxiliary power storage device BB1 continues.

If, on the other hand, it is determined in step S20 that the SOC of the first auxiliary power storage device BB1 (i.e., the SOC1) is less than the lower limit value TL (i.e., YES in step S20), the ECU 22 outputs a switching signal SW to the connecting device 18 to turn the system relay RY1 of the connecting device 18 off and turn the system relay RY2 of the connecting device 18 on. Upon receiving this switching signal SW, the connecting device 18 switches from the first auxiliary power storage device BB1 to the second auxiliary power storage device BB2 (i.e., step S30). As a result, EV running using the second auxiliary power storage device BB2 is realised (i.e., step S40).

Next, the ECU 22 determines whether the SOC of the second auxiliary power storage device BB2 (i.e., the SOC2) is less than the lower limit value TL (i.e., step S50). If the SOC2 is equal to or greater than the lower limit value TL (i.e., NO in step S50), the process returns to step S40 and EV running using the second auxiliary power storage device BB2 continues.

If, on the other hand, it is determined in step S50 that the SOC of the second auxiliary power storage device BB2 (i.e., the SOC2) is less than the lower limit value TL (i.e., YES in step S50), the. ECU 22 determines whether the first auxiliary power storage device BB1 that is not being used is in a relaxed state (i.e., step S60). Incidentally, the determination as to whether the first auxiliary power storage device BB1 has reached a relaxed state can be made by any one of a variety of methods, such as whether a predetermined period of time has passed after the first auxiliary power storage device BB1 has been electrically disconnected, whether the rate of change over time in the voltage Vb2 of the first auxiliary power storage device BB1 is equal to or less than a predetermined value, or whether the concentration difference of the reactant in the electrolyte solution or in the active battery material is equal to or less than a predetermined value using a battery reaction model. If it is determined in step S60 that the first auxiliary power storage device BB1 has not reached a relaxed state (i.e., NO in step S60), the process jumps ahead to step S220 which will be described later.

If, on the other hand, it is determined in step S60 that the first auxiliary power storage device BB1 is in a relaxed state (i.e., YES in step S60), the ECU 22 measures the OCV of the first auxiliary power storage device BB1 based on the detection value of the voltage sensor 16-2 (i.e., step S70). The ECU 22 estimates the SOC of the first auxiliary power storage device BB1 (i.e., the SOC1) based on the measured OCV using an OCV-SOC map or the like prepared in advance (i.e., step S80).

Next, the ECU 22 determines whether the difference of the estimated SOC of the first auxiliary power storage device BB1 (i.e., the SOC1) minus the lower limit value TL is larger than a predetermined threshold value (such as 5%) (i.e., step S90). If it is determined that the difference of the SOC1 minus the lower limit value TL is equal to or less than the threshold value (i.e., NO in step S90), the process jumps ahead to step S220 which will be described later.

If, on the other hand, it is determined in step S90 that the difference of the SOC1 minus the lower limit value TL is larger than the threshold value (i.e., YES in step S90), the ECU 22 outputs a switching signal SW to the connecting device 18 to turn the system relay RY1 of the connecting device 18 on and turn the system relay RY2 of the connecting device 18 off. Upon receiving this switching signal SW, the connecting device 18 again switches from the second auxiliary power storage device BB2 to the first auxiliary power storage device BB1 (i.e., step S100). As a result, EV running using the first auxiliary power storage device BB1 is realised again (i.e., step S110).

Referring to FIG. 7, while the first auxiliary power storage device BB1 is being used, the ECU 22 calculates the SOC of the first auxiliary power storage device BB1 (i.e., the SOC1) by integrating the current Ib2 detected by the current sensor 14-2 (FIG. 1) (i.e., step S120). Then the ECU 22 determines whether this calculated SOC1 is less than the lower limit value TL (i.e., step S130).

If it is determined that the SOC1 is less than the lower limit value TL (i.e., YES in step S130), the ECU 22 determines whether the second auxiliary power storage device BB2 that is not being used is in a relaxed state (i.e., step S140). Incidentally, the determination as to whether the second auxiliary power storage device BB2 has reached a relaxed state is made the same way that the determination as to whether the first auxiliary power storage device BB1 has reached a relaxed state is made. If it is determined that the second auxiliary power storage device BB2 has not reached a relaxed state (i.e., NO in step S140), the process jumps ahead to step S220 which will be described later.

If, on the other hand, it is determined in step S140 that the second auxiliary power storage device BB2 is in a relaxed state (i.e., YES in step S140), the ECU 22 measures the OCV of the second auxiliary power storage device BB2 based on the detection value of the voltage sensor 16-3 (i.e., step S150): Then the ECU 22 estimates the SOC of the second auxiliary power storage device. BB2 (i.e., the SOC2) based on the measured OCV using an OCV-SOC map or the like prepared in advance (i.e., step S160).

Next, the ECU 22 determines whether the difference of the estimated SOC of the second auxiliary power storage device BB2 (i.e., the SOC2) minus the lower limit value TL is greater than a predetermined threshold value (such as 5%) (i.e., step S170). If it is determined that the difference of the SOC2 minus the lower limit value TL is equal to or less than the threshold value (i.e., NO in step S170), the process jumps ahead to step S220 which will be described later.

If, on the other hand, it is determined in step S170 that the difference of the SOC2 minus the lower limit value TL is greater than the threshold value (i.e., YES in step S170), the ECU 22 outputs a switching signal SW to the connecting device 18 to turn the system relay RY1 of the connecting device 18 off and turn the system relay RY2 of the connecting device 18 on. Upon receiving this switching signal SW, the connecting device 18 again switches from the first auxiliary power storage device BB1 to the second auxiliary power storage device BB2 (i.e., step S180). As a result, EV running using the second auxiliary power storage device BB2 is realised again (i.e., step 190).

During EV running using the second auxiliary power storage device BB2, the ECU 22 calculates the SOC of the second auxiliary power storage device BB2 (i.e., the SOC2) by integrating the current Ib3 detected by the current sensor 14-3 (FIG. 1) (i.e., step S200). Then the ECU 22 determines whether this calculated SOC2 is less than the lower limit value TL (i.e., step S210). Next, the ECU 22 determines whether this calculated SOC2 is less than the lower limit value TL (step S210).

If it is determined that the SOC2 is less than the lower limit value TL (i.e., YES in step S210), the ECU 22 switches from EV running to HV running (i.e., running in the HV mode) (i.e., step S220). More specifically, the ECU 22 outputs a switching signal SW to the connecting device 18 to turn off both of the system relays RY1 and RY2 of the connecting device 18, and controls the first converter 12-1 so that the SOC of the main power storage device BA comes to match a target value CL or comes within a target range that includes that target value CL.

Incidentally, in the description above, the timing at which the OCV of the first auxiliary power storage device BB1 is measured and the SOC is estimated is the timing at which the SOC of the second auxiliary power storage device BB2 has reached the lower limit value TL. However, if the first auxiliary power storage device BB1 has reached the relaxed state before the SOC of the second auxiliary power storage device BB2 reaches the lower limit value TL, the OCV of the first auxiliary power storage device BB1 may be measured and the SOC estimated at that timing. Incidentally, in the description above, the reason for having the timing at which the OCV of the first auxiliary power storage device BB1 is measured and the SOC is estimated be the timing at which the SOC of the second auxiliary power storage device BB2 has reached the lower limit value TL is to buy time to help the first auxiliary power storage device BB1 reach the most relaxed state possible.

Moreover, the timing at which the OCV of the second auxiliary power storage device BB2 is measured and the SOC is estimated is also the timing at which the SOC of the first auxiliary power storage device BB1 has reached the lower limit value TL. However, if the second auxiliary power storage device BB2 has reached the relaxed state before the SOC of the first auxiliary power storage device BB1 reaches the lower limit value TL, the OCV of the second auxiliary power storage device BB2 may be measured and the SOC estimated at that timing.

As described above, in this first example embodiment, the auxiliary power storage devices may be switched and used in order, with the first auxiliary power storage device BB1 being used first and the second auxiliary power storage device BB2 being used second. After it has been determined that the SOC of the first auxiliary power storage device BB1 has reached the lower limit value TL and the auxiliary power storage device has been switched from the first auxiliary power storage device BB1 to the second auxiliary power storage device BB2, the OCV of the first auxiliary power storage device BB1 that is not being used is measured and the SOC of that first auxiliary power storage device BB1 is estimated based on that measured OCV. If this estimated SOC is higher than the lower limit value TL, then after it has been determined that the SOC of the second auxiliary power storage device BB2 has reached the lower limit value TL, the auxiliary power storage device is switched from the second auxiliary power storage device BB2 back to the first auxiliary power storage device BB1 such that the first auxiliary power storage device BB1 is used again. Furthermore, while the first auxiliary power storage device BB1 is being used again, the OCV of the second auxiliary power storage device BB2 that is not being used is measured and the SOC of that second auxiliary power storage device BB2 is estimated based on that measured OCV. If this estimated SOC is higher than the lower limit value TL, then after it has been determined that the SOC of the first auxiliary power storage device BB1 has reached the lower limit value TL, the auxiliary power storage device is again switched from the first auxiliary power storage device BB1 to the second auxiliary power storage device BB2 such that the second auxiliary power storage device BB2 is used again. Therefore, according to this first example embodiment, the electric power stored in the first auxiliary power storage device BB1 and the second auxiliary power storage device BB2 is able to be sufficiently used up.

Hereinafter, a second example embodiment of the invention will be described in detail with reference to the drawings. Incidentally, like or corresponding parts will be denoted by like reference characters and descriptions of those parts will not be repeated.

When the auxiliary power storage device is switched between the first auxiliary power storage device BB1 and the second auxiliary power storage device BB2 as shown in FIG. 3, if the running distance per trip is short, the second auxiliary power storage device BB2 will not be used at all so the SOC of the second auxiliary power storage device BB2 will continue to be high for an extended period of time. Power storage devices tend to deteriorate faster at a higher SOC, so the method of use described above may accelerate the rate at which the second auxiliary power storage device BB2 deteriorates. Therefore, in this second example embodiment, if the SOC of the second auxiliary power storage device BB2 remains high for an extended period of time, some of the energy stored in the second auxiliary power storage device BB2 is transferred to the first auxiliary power storage device BB1 to slow down the rate at which the second auxiliary power storage device BB2 deteriorates.

Incidentally, if both of the system relays RY1 or RY2 (FIG. 1) of the connecting device 18 are turned on to transfer energy from the first auxiliary power 20 storage device BB1 to the second auxiliary power storage device BB2, it will cause the first auxiliary power storage device BB1 and the second auxiliary power storage device BB2 to short. Therefore, in this second example embodiment, first the second auxiliary power storage device BB2 is connected by the connecting device 18 and energy is transferred from the second auxiliary power storage device BB2 to the main power storage device BA. Then the connection is switched from the second auxiliary power storage device BB2 to the first auxiliary power storage device BB1 and energy is transferred from the main power storage device BA to the first auxiliary power storage device BB1.

The overall structure of the electric vehicle in this second example embodiment is the same as that of the electric vehicle 100 shown in FIG. 1. Also, with regards to the method of use of the first auxiliary power storage device BB1 and the second auxiliary power storage device BB2, the basic concept of using the first auxiliary power storage device BB1 first and then using the second auxiliary power storage device BB2 is the same as it is in the first example embodiment.

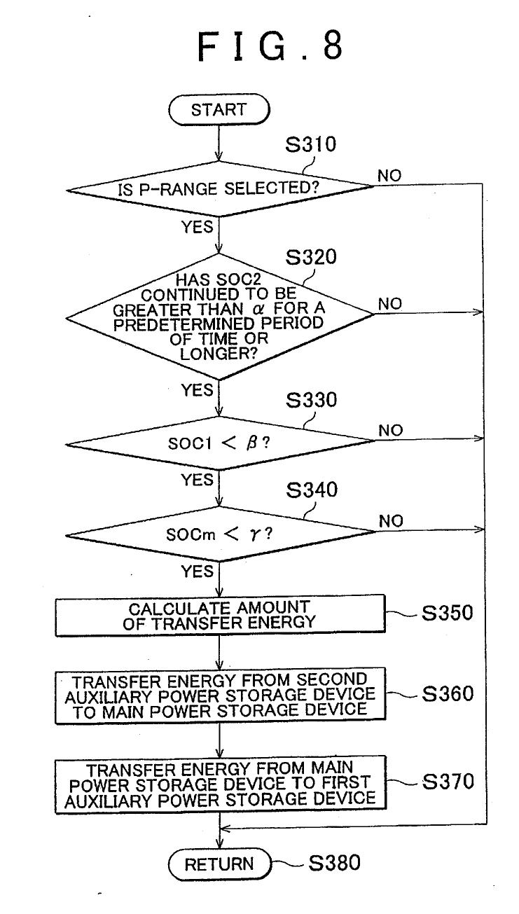

FIG. 8 is a flowchart illustrating an energy transfer routine executed by the ECU according to the second example embodiment of the invention. Incidentally, the routine shown in this flowchart is called up from a main routine and executed at regular intervals of time or when a predetermined condition is satisfied.

Referring to FIG. 8, the ECU 22 determines whether a P-range (i.e., a Park-range) is selected by a shift lever for selecting the shift position (i.e., step S310). If a range other than the P-range is selected (i.e., NO in step S310), the process proceeds to step S380 without any other steps being performed.

If it is determined in step S310 that the P-range is selected (i.e., YES in step S310), the ECU 22 then determines whether the SOC of the second auxiliary power storage device BB2 (i.e., the SOC2) has continued to be higher than a predetermined value a for a predetermined period of time or longer (i.e., step S320). This predetermined value α is a preset value for determining that the SOC of the second auxiliary power storage device BB2 is high enough that it may affect the rate at which the second auxiliary power storage device BB2 deteriorates. If the SOC2 has not continued to be higher than the predetermined value α for the predetermined period of time (i.e., NO in step S320), the process proceeds on to step S380.

If, on the other hand, it is determined in step S320 that the SOC2 has continued to be higher than the predetermined value α for the predetermined period of time (i.e., YES in step S320), then the ECU 22 determines whether the SOC of the first auxiliary power storage device BB1 (i.e., the SOC1) is less than a predetermined value β (i.e., step S330). Incidentally, this predetermined value β is a preset value for determining whether the first auxiliary power storage device BB1 is able to receive energy transferred from the second auxiliary power storage device BB2. If it is determined that the SOC1 is equal to or greater than the predetermined value β (i.e., NO in step S330), the process proceeds on to step S380.

If, on the other hand, it is determined in step S330 that the SOC1 is less than the predetermined value β (i.e., YES in step S330), the ECU 22 determines whether the SOC of the main power storage device BA (i.e., SOCm) is less than a predetermined value (i.e., step S340). This predetermined value γ is a preset value for determining whether the main power storage device BA that is used as a temporary buffer is able to receive the energy transferred from the second auxiliary power storage device BB2. If it is determined that the SOCm is equal to or greater than this predetermined value γ (i.e., NO in step S340), the process proceeds on to step S380.

If, on the other hand, it is determined in step S340 that the SOCm is less than the predetermined value γ (i.e., YES in step S340), the ECU 22 calculates the amount of energy to be transferred from the first auxiliary power storage device. BB1 to the second auxiliary power storage device BB2 (i.e., step S350). For example, in view of the relationship between the SOC and the rate of deterioration of a power storage device, the amount of energy to be transferred (i.e., simply referred to as the amount of transfer energy) is determined to obtain an SOC such that the rate at which the second auxiliary power storage device BB2 deteriorates is the same as the rate at which the first auxiliary power storage device BB1 deteriorates. Alternatively, the deterioration rates may be estimated from the use history of the power storage devices and those rates then compared between the first auxiliary power storage device BB1 and the second auxiliary power storage device BB2. Energy may then be transferred from the more deteriorated power storage device to the less deteriorated power storage device, and the deterioration rate may be obtained so that an estimated deterioration value for each power storage device is approached when the target life is reached. The amount of transfer energy may then be obtained to achieve an SOC that corresponds to that deterioration rate.

Then when the amount of transfer energy is calculated, the ECU 22 first transfers energy from the second auxiliary power storage device BB2 to the main power storage device BA (i.e., step S360). As a result, the transferred energy is stored in the main power storage device BA as a buffer. Next, the ECU 22 transfers that energy from the main power storage device BA to the first auxiliary power storage device BB1 (i.e., step S370). As a result, the transfer energy is transferred to the first auxiliary power storage device BB1.

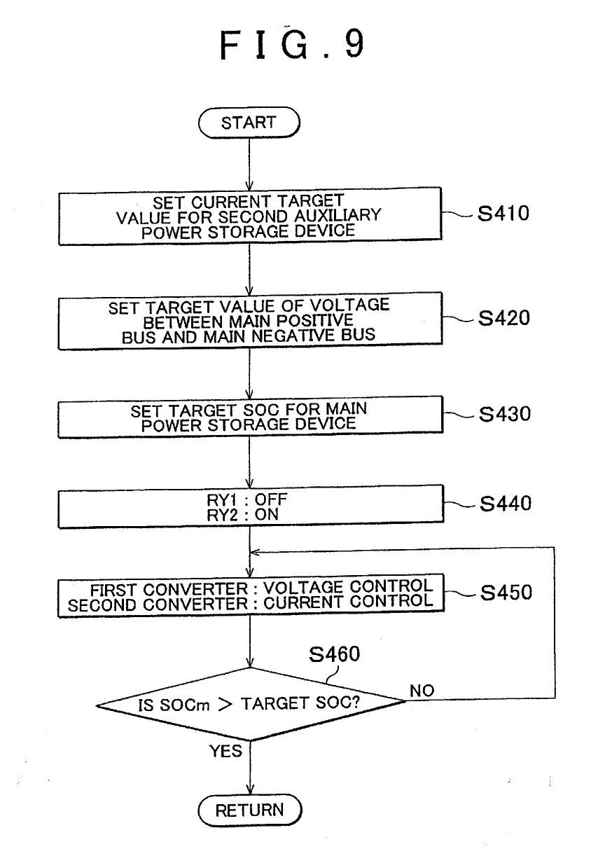

FIG. 9 is a flowchart illustrating a routine for transferring energy from the second auxiliary power storage device BB2 to the main power storage device BA. Incidentally, the routine shown in this flowchart is called up from step S360 in FIG. 8 and executed.

Referring to FIG. 9, the ECU 22 sets a target value for the current Ib3 output from the second auxiliary power storage device BB2 (i.e., step S410). Next, the ECU 22 sets a target value for the voltage Vh between the main positive bus MPL and the main negative bus MNL (i.e., step S420). Then the ECU 22 sets a target SOC for the main power storage device BA based on the amount of transfer energy from the second auxiliary power storage device BB2 (i.e., step. S430).

Once this is done, the ECU 22 turns the system relay RY1 off and the system relay RY2 on by outputting a switching signal SW to the 18 (FIG. 1) (i.e., step S440). Then the ECU 22 voltage controls the first converter 12-1 such that the voltage Vh comes to match the target value, and current controls the second converter 12-2 such that the current Ib3 output from the second auxiliary power storage device BB2 comes to match the target value (i.e., step S450).

Next, the ECU 22 determines whether the SOC of the main power storage device BA (i.e., the SOCm) exceeds a target SOC (i.e., step S460). If it is determined that the SOCm exceeds the target SOC (i.e., YES in step S460), the first converter 12-1 and the second converter 12-2 are stopped and the process returns to step S360 shown in FIG. 8.

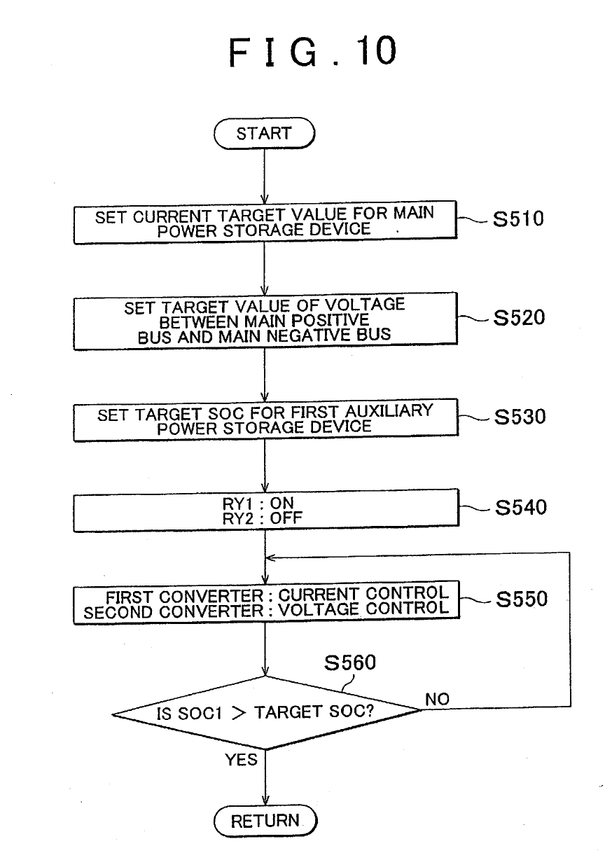

FIG. 10 is a flowchart illustrating routine for transferring energy from the main power storage device BA to the second auxiliary power storage device BB1. Incidentally, the routine shown in this flowchart is called up from step S370 in FIG. 8 and executed.

Referring to FIG. 10, the ECU 22 sets a target value for the current Ib1 output from the main power storage device BA (i.e., step S510). Next, the ECU 22 sets a target value for the voltage Vh between the main positive bus MPL and the main negative bus MNL (i.e., step S520). Then the ECU 22 sets a target SOC for the first auxiliary power storage device BB1 based on the amount of transfer energy (i.e., step S530).

Then the ECU 22 turns the system relay RY1 on and the system relay RY2 off by outputting a switching signal SW to the connecting device 18 (FIG. 1) (i.e., step S540). Next, the ECU 22 current controls the first converter 12-1 such that the current Ib1 output from the main power storage device BA comes to match the target value, and voltage controls the second converter 12-2 such that the voltage Vh comes to match the target value (i.e., step S550).

Then the ECU 22 determines whether the SOC of the first auxiliary power storage device BB1 (i.e., the SOC1) exceeds the target SOC (i.e., step S560). If it is determined that the SOC1 exceeds the target SOC (i.e., YES in step S560), then the first converter 12-1 and the second converter 12-2 are stopped and the process returns to step S370 shown in FIG. 8.

Incidentally, in the description above, the routine for transferring energy from the second auxiliary power storage device BB2 to the first auxiliary power storage device BB1 can only be executed when the P-range is selected, i.e., only when the vehicle is stopped. However, this energy transfer routine is not limited to being executed only when the P-range is selected. For example, it may also be executed when the ignition key or the start switch for starting the vehicle is off.

As described above, this second example embodiment makes it possible to slow the rate of deterioration of the second auxiliary power storage device BB2.

Next, a third example embodiment of the invention will be described in detail with reference to the drawings. Incidentally, like or corresponding parts will be denoted by like reference characters and descriptions of those parts will not be repeated.

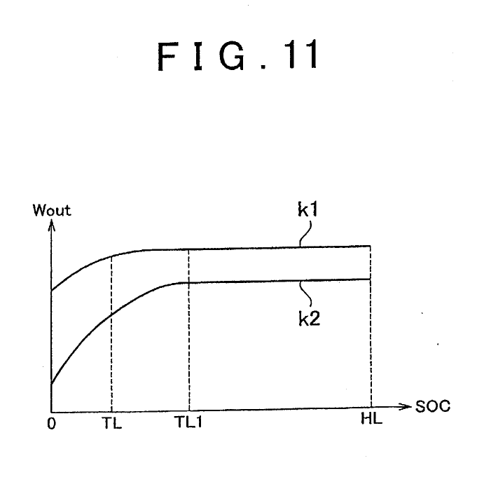

FIG. 11 is a graph showing the relationship between the SOC of a power storage device and the allowable power output Wout that represents the maximum value of power able to be output instantaneously from the power storage device. Referring to FIG. 11, the curved line k1 represents the allowable output power Wout when the power storage device is at normal temperature, and the curved line k2 represents the allowable output power Wout when temperature of the power storage device is low.

As shown in FIG. 11, the allowable power output Wout is lower in the region where the SOC is low. Also, the tendency for the allowable power output Wout to become smaller when the SOC is low becomes more pronounced as the temperature of the power storage device becomes lower. For example, when the temperature of the power storage device is low (the curved line k2), the allowable power output Wout starts to decrease when the SOC decreases to a lower limit value TL1 that is greater than the lower limit value TL. Taking into account the output characteristics of this kind of power storage device, problems such as those described below occur when a switch such as that shown in FIG. 3 is performed between the first auxiliary power storage device BB1 and the second auxiliary power storage device BB2.

When the required power for the vehicle is unable to be obtained with only the output from the power storage devices during EV running, the engine 36 (FIG. 1) is used to compensate for that insufficiency. Here, with a user that mainly uses only EV running (i.e., with a user that takes only short trips in which the running distance per trip is short), the allowable power output Wout is small in the region where the SOC of the first auxiliary power storage device BB1 is low so the engine 36 is operated frequently which reduces fuel efficiency. Incidentally, the fuel efficiency becomes remarkably worse as the temperature decreases.

Therefore, in this third example embodiment, for example, the power storage device is switched from the first auxiliary power storage device BB1 to the second auxiliary power storage device BB2 at the lower limit value TL1 (>TL) shown in FIG. 11. As a result, the power that is able to be output from the power storage device is ensured, which minimises the operation of the engine 36, thereby improving fuel efficiency. It is also possible to avoid a case in which the SOC of the second auxiliary power storage device BB2 is constantly high, which in turn also helps to slow the deterioration of the second auxiliary power storage device BB2.

The overall structure of the electric vehicle in this third example embodiment is the same as that of the electric vehicle 100 shown in FIG. 1.

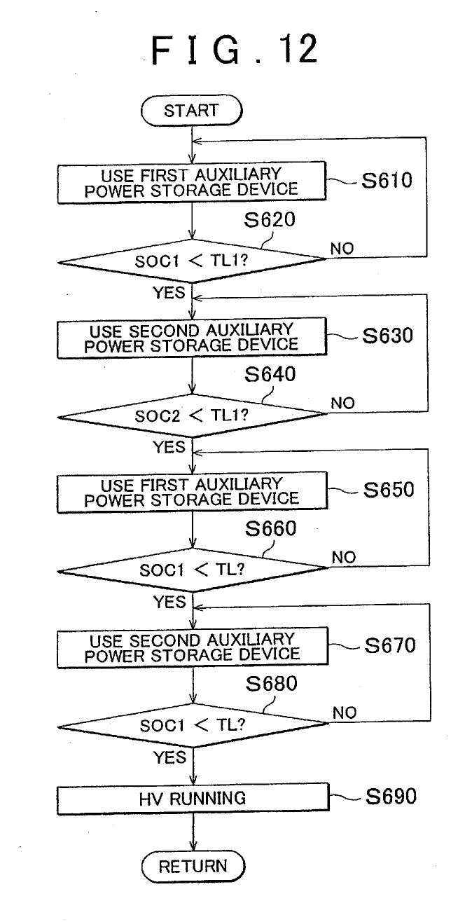

FIG. 12 is a flowchart illustrating a switching control routine of the first auxiliary power storage device BB1 and the second auxiliary power storage device BB2 that is executed by the ECU 22 according to the third example embodiment. Incidentally, the routine shown in the flowcharts is called up from a main routine and executed at regular intervals of time or when a predetermined condition is satisfied.

Referring to FIG. 12, the ECU 22 turns the system relay RY1 of the connecting device 18 (FIG. 1) on and the system relay RY2 of the connecting device 18 off after the main power storage device BA, the first auxiliary power storage device BB1, and the second auxiliary power storage device BB2 have finished being charged by the charger 26. As a result, the first auxiliary power storage device BB1 is used first (i.e., step S610). Then the ECU 22 determines whether the SOC of the first auxiliary power storage device BB1 (i.e., the SOC1) is less than the lower limit value TL1 (>TL) (i.e., step S620).

If it is determined that the SOC1 is less than the lower limit value TL1 (i.e., YES in step S620), the ECU turns off the system relay RY1 and turns on the system relay RY2. As a result, the second auxiliary power storage device BB2 is used (i.e., step S630). Then the ECU 22 determines whether the SOC of the second auxiliary power storage device BB2 (i.e., the SOC2) is less than the lower limit value TL1 (i.e., step S640).

If it is determined that the SOC2 is less than the lower limit value TL1 (i.e., YES in step S640), the ECU 22 turns the system relay RY1 on and the system relay RY2 off. As a result, the first auxiliary power storage device. BB1 is used again (i.e., step S650). Then the ECU 22 determines whether the SOC of the first auxiliary power storage device BB1 (i.e., the SOC1) is less than the lower limit value TL (i.e., step S660).

If it is determined that the SOC1 is less than the lower limit value TL (i.e., YES in step S660), the ECU 22 turns the system relay RY1 off and the system relay RY2 on. As a result, the second auxiliary power storage device BB2 is used again (i.e., step S670). Then the ECU 22 determines whether the SOC of the second auxiliary power storage device BB2 (i.e., the SOC2) is less than the lower limit value TL (i.e., step S680).

If it is determined that the SOC2 is less than the lower limit value TL (i.e., YES in step S680), the ECU 22 switches from EV running to HV running (i.e., step S690). More specifically, the ECU 22 controls the first converter 12-1 so that the SOC of the main power storage device BA comes to match the target value CL or comes within a target range that includes that target value CL.

As described above, in this third example embodiment, when mainly only EV running is used, it is possible to minimise the operation of the engine 36 in order to compensate for insufficient output due to the reduced allowable power output Wout. Therefore, this third example embodiment makes it possible to improve fuel efficiency. Also, with this third example embodiment, it is possible to avoid a case in which the SOC of the second auxiliary power storage device BB2 is constantly high, which makes it possible to slow the deterioration of the second auxiliary power storage device BB2.

Incidentally, although the example embodiments described above describe cases in which two auxiliary power storage devices are used, three or more auxiliary power storage device may also be used.

Also, in the description above, the electric vehicle 100 includes the first MG 32-1 and the second MG 32-2, though the number of motor-generators in the electric vehicle 100 is not limited to two.

Further, in the description above, a series-parallel hybrid vehicle in which power from the engine 36 can be split by the power split device 34 and transmitted to both the driving wheels 38 and the first MG 32-1 is described. However, the invention may also be applied to another type of hybrid vehicle. That is, the invention may also be applied to, for example, a so-called series hybrid vehicle that uses the engine 36 only to drive the first MG 32-1 and generates driving force for the vehicle using only the second MG 32-2, a hybrid vehicle in which only regenerated energy, of the kinetic energy generated by the engine 36, is recovered as electric energy, or a motor assist hybrid in which the engine is used as the primary power source and the motor is used to assist when necessary.

Also, the invention may also be applied to an electric vehicle that runs using only electricity and is not provided with an engine 36, or a fuel cell vehicle that is provided with a fuel cell in addition to a power storage device as the direct current power supply.

Incidentally, in the description above, the first auxiliary power storage device BB1 and the second auxiliary power storage device BB2 may correspond to the plurality of power storage devices of the invention, and the ECU 22 may correspond to the control apparatus of the invention. Also, the SOC estimating portion 52 may correspond to the state-of-charge estimating portion, and the first inverter 30-1, the second inverter 30-2, the first MG 32-1, and the second MG 32-2 may correspond to the electrical load apparatus of the invention. Furthermore, the first converter 12-1 may correspond to the first voltage converter of the invention, and the second converter 12-2 may correspond to the second voltage converter of the invention. Moreover, the charger 26 and the charging inlet 27 may correspond to the charging device of the invention.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

1. A power supply system comprising:
a plurality of power storage devices;
a connecting device that is provided between the plurality of power storage devices and an electrical system that receives a supply of electric power from the plurality of power storage devices, and is structured to selectively electrically connect and disconnect the plurality of power storage devices to and from the electrical system; and
a control apparatus that sequentially selects one of the plurality of power storage devices, connects the selected power storage device to the electrical system, and controls the connecting device to disconnect the remaining power storage device from the electrical system,
wherein the control apparatus includes a) a state-of-charge estimating portion that estimates the state-of-charge of each of the plurality of power storage devices, b) a determining portion that determines whether the state-of-charge of the power storage device that is connected to the electrical system by the connecting device has reached a first lower limit value, and c) a switch controlling portion that, when it is determined by the determining portion that the state-of-charge of the power storage device that is connected to the electrical system has reached the first lower limit value, controls the connecting device to disconnect the power storage device that is connected to the electrical system from the electrical system and connect one of the remaining power storage devices having a state-of-charge that has not reached the first lower limit value to the electrical system,
wherein the state-of-charge estimating portion estimates the state-of-charge of the used power storage device, for which it has been determined that the state-of-charge has reached the first lower limit value and has thus been disconnected from the electrical system, based on an open circuit voltage of that power storage device, and
wherein if the state-of-charge estimated based on the open circuit voltage of the used power storage device is higher than the first lower limit value, after the remaining power storage device has been used, the switching control portion controls the connecting device to connect the used power storage device to the electrical system again and disconnect the remaining power storage device from the electrical system, and
wherein the switch controlling portion does not reconnect the used power storage device to the electrical system if the state-of-charge estimated based on the open circuit voltage of the used power storage device is equal to or lower than the first lower limit value.

2. The power supply system according to claim 1, wherein the state-of-charge estimating portion estimates the state-of-charge of the used power storage device based on the open circuit voltage of that power storage device when the state-of-charge of the remaining power storage device reaches the first lower limit value.

3. The power supply system according to claim 1, wherein the control apparatus operates the switching control portion when a voltage change of the open circuit voltage, that is due to a diffusion phenomenon of reactants in an electrolyte solution or active battery material that occurs after current has run through the power storage device that is connected to the electrical system, has converged.

4. The power supply system according to claim 1, wherein the electrical supply system includes an electrical load apparatus, a main power storage device that is different than the plurality of power storage devices, a first voltage converter provided between the main power storage device and a power line for supplying power to the electrical load apparatus, a second voltage converter provided between the power line and the connecting device, and a charging device for charging the main power storage device and the plurality of power storage devices from an external power supply.

5. The power supply system according to claim 1, wherein when a temporarily unused condition of the power storage device that is connected to the electrical system is satisfied, the switching control portion transfers electric power from the remaining power storage device to the power storage device that is connected to the electrical system, even if the state-of-charge of the power storage device that is connected to the electrical system has not reached the first lower limit value.

6. The power supply system according to claim 1, wherein:
the plurality of power storage devices includes a first auxiliary power storage device and a second auxiliary power storage device;
when it is determined that the state-of-charge of the first auxiliary power storage device that is connected to the electrical system has reached a second lower limit value that is greater than the first lower limit value before switching control that is based on the first lower limit value is performed, the switching control portion disconnects the first auxiliary power storage device that is connected to the electrical system from the electrical system and connects the second auxiliary power storage device to the electrical system; and
when it is determined that the state-of-charge of the second auxiliary power storage device that is connected to the electrical system has reached the second lower limit value that is greater than the first lower limit value before the switching control that is based on the first lower limit value is performed, the switching control portion disconnects the second auxiliary power storage device that is connected to the electrical system from the electrical system and connects the first auxiliary power storage device to the electrical system.

7. An electric vehicle comprising:
the power supply system according to claim 1; and
a driving force generating portion that receives a supply of electric power from the power supply system and generates driving force for the vehicle.

8. A control method of a power supply system that includes a plurality of power storage devices, and a connecting device that is provided between the plurality of power storage devices and an electrical system that receives a supply of electric power from the plurality of power storage devices, and is structured to selectively electrically connect and disconnect the plurality of power storage devices to and from the electrical system, comprising:
determining whether a state-of-charge of the power storage device, that is connected to the electrical system has reached a first lower limit value;
controlling the connecting device to disconnect the power storage device that is connected to the electrical system from the electrical system and connect one of the remaining power storage devices having a state-of-charge that has not reached the first lower limit value to the electrical system, when it is determined that the state-of-charge of the power storage device that is connected to the electrical system has reached the first lower limit value;
estimating the state-of-charge of the used power storage device, for which it has been determined that the state-of-charge has reached the first lower limit value and has thus been disconnected from the electrical system, based on an open circuit voltage of that power storage device; and
controlling the connecting device to connect the used power storage device to the electrical system again and disconnect the remaining power storage device from the electrical system after the remaining power storage device has been used, when the state-of-charge estimated based on the open circuit voltage of the used power storage device is higher than the first lower limit value
controlling the connecting device not to reconnect the used power storage device to the electrical system if the state-of-change estimated based on the open circuit voltage of the used power storage device is equal to or lower than the first lower limit value.

9. The control method of the power supply system according to claim 8, wherein the state-of-charge of the used power storage device is estimated based on the open circuit voltage of that power storage device when the state-of-charge of the remaining power storage device reaches the first lower limit value.

10. The control method of the power supply system according to claim 8, the power storage device is switched when a voltage change of the open circuit voltage, that is due to a diffusion phenomenon of reactants in an electrolyte solution or active battery material or the like that occurs after current has run through the power storage device that is connected to the electrical system, has converged.

11. The control method of the power supply system according to claim 8, wherein the electrical system includes an electrical load apparatus, a main power storage device that is different than the plurality of power storage devices, a first voltage converter provided between the main power storage device and a power line for supplying power to the electrical load apparatus, a second voltage converter provided between the power line and the connecting device, and a charging device for charging the main power storage device and the plurality of power storage devices from an external power supply.

12. The control method of the power supply system according to claim 8, wherein when a temporarily unused condition of the power storage device that is connected to the electrical system is satisfied, electric power is transferred from the remaining power storage device to the power storage device that is connected to the electrical system, even if the state-of-charge of the power storage device that is connected to the electrical system has not reached the first lower limit value.

13. The control method of the power supply system according to claim 8, wherein:
the plurality of power storage devices includes a first auxiliary power storage device and a second auxiliary power storage device;
when it is determined that the state-of-charge of the first auxiliary power storage device that is connected to the electrical system has reached a second lower limit value that is greater than the first lower limit value before switching control that is based on the first lower limit value is performed, the first auxiliary power storage device that is connected to the electrical system is disconnected from the electrical system and the second auxiliary power storage device is connected to the electrical system; and
when it is determined that the state-of-charge of the second auxiliary power storage device that is connected to the electrical system has reached the second lower limit value that is greater than the first lower limit value before the switching control that is based on the first lower limit value is performed, the second auxiliary power storage device that is connected to the electrical system is disconnected from the electrical system and the first auxiliary power storage device is connected to the electrical system.
